(19) United States
(12) Patent Application Publication
(10) Pub. No.: US 2012/0326618 A1
(43) Pub. Date: Dec. 27, 2012

(54) HARMONIC RIPPLE-CURRENT LIGHT EMITTING DIODE (LED) DRIVER CIRCUITRY AND METHOD

(75) Inventor: Jang Dae Kim, San Jose, CA (US)

(73) Assignee: National Semiconductor Corporation, Santa Clara, CA (US)

(21) Appl. No.: 13/168,260

(22) Filed: Jun. 24, 2011

(51) Int. Cl. H05B 37/02

(52) U.S. Cl. 315/224

(57) ABSTRACT

In accordance with the presently claimed invention, circuitry and a method are provided for using a voltage to drive a light emitting diode (LED) load including one or more LEDs. The incoming voltage is switched and inductively conditioned to drive the LED load in such a manner as to cause the LED load to appear as a substantially linear resistive load, thereby maximizing the power factor presented to an AC power grid serving as the source of the input voltage.

### BACKGROUND

1. Field of the Invention

The present invention relates to circuits and methods for driving light emitting diodes (LEDs), and in particular, to buck LED driver circuits presenting linear resistive loads to the AC power source while reducing requirements for large energy storage elements.

2. Related Art

Light emitting diodes have non-linear current-voltage (I-V) characteristics, similar to those of non-illuminating diodes, e.g., diodes used for AC voltage rectification. High brightness LED lighting often uses specialized electronic circuitry to drive the non-linear LED loads. Perhaps most common are buck LED driver circuits for high brightness LED lighting that receives power from the AC power grid.

A conventional buck LED driver is driven by a constant DC voltage source and in turn drives an LED load with a constant DC current. Such an LED load often includes multiple LEDs connected in series. The buck LED driver converts the input DC voltage to a DC current for the LED load. In other words, the buck LED driver operates as a transconductor, converting the input voltage to output load current. The input DC voltage is generally provided by an AC-to-DC converter plugged in the AC mains.

Conventional driver circuits providing constant DC current to LED loads typically require large energy storage elements in the AC-to-DC power conversion circuitry. A large electrolytic capacitor is often used for such energy storage element. However, such electrolytic capacitors are bulky and exhibit poor reliability in the typical extreme environments of LED lighting. Constant DC current driving of an LED load also presents a poor, i.e., low, power factor to the AC-to-DC power conversion circuit, unless specialized power factor correction (PFC) circuitry is also used. The PFC circuitry, however, adds to the system cost of the LED lighting fixture and still requires the large electrolytic capacitor.

### BRIEF DESCRIPTION OF THE DRAWINGS

FIG. 1 is a schematic diagram of a conventional buck LED driver circuit.

FIG. 2 is a signal diagram depicting the input voltage and current for the circuit of FIG. 1 while driving an LED load with constant power.

FIG. 3 is a signal diagram depicting the input voltage, current and power for driving an LED load with modulated current.

FIG. 4 is a schematic diagram of a rectified-AC buck LED driver in accordance with one embodiment of the presently claimed invention.

FIG. 5 is a signal diagram depicting simulation results for the circuit of FIG. 4.

FIG. 6 is a schematic diagram of a rectified-AC buck LED driver with power feedback in accordance with another embodiment of the presently claimed invention.

FIG. 7 is a signal diagram depicting simulation results for the circuit of FIG. 6.

FIG. 8 is a schematic diagram of a rectified-AC buck LED driver circuit with power feedback and pulse width modulation (PWM) in accordance with another embodiment of the presently claimed invention.

FIG. 9 is a signal diagram depicting simulation results for the circuit of FIG. 8.

FIG. 10 is an alternate schematic diagram of a ripple-current buck LED driver in accordance with another embodiment of the presently claimed invention.

FIG. 11 depicts a subcircuit for conditioning voltage from the AC power grid to provide the input voltage for the circuitry of FIGS. 4, 6, 8 and 10.

FIG. 12 is an alternate subcircuit for providing the reference signal in the circuit of FIG. 4.

FIG. 13 is an alternate subcircuit for providing the reference signal in the circuit of FIG. 10.

FIG. 14 is a schematic diagram of an exemplary embodiment of a squaring circuit suitable for use in the circuitry of FIGS. 4, 6 and 8.

FIG. 15 is a signal diagram depicting simulation results for the circuit of FIG. 14.

FIG. 16 is a schematic diagram of an exemplary embodiment of a square-root circuit suitable for use in the circuitry of FIG. 10.

FIG. 17 is a signal diagram depicting simulation results for the circuit of FIG. 16.

### DETAILED DESCRIPTION

The following detailed description is of example embodiments of the presently claimed invention with references to the accompanying drawings. Such description is intended to be illustrative and not limiting the scope of the present invention. Such embodiments are described in sufficient detail to enable one of ordinary skill in the art to practice the subject invention, and it will be understood that other embodiments may be practiced with some variations without departing from the spirit or scope of the subject invention.

Throughout the present disclosure, absent a clear indication to the contrary from the context, it will be understood that individual circuit elements as described may be singular or plural in number. For example, the terms “circuit” and “circuitry” may include either a single component or a plurality of components, which are either active and/or passive and are connected or otherwise coupled together (e.g., as one or more integrated circuit chips) to provide a described function. Additionally, the term “signal” may refer to one or more current waveforms, one or more voltage waveforms, or a discrete data signal. Within the drawings, like or related elements will have like or related alpha, numeric or alphanumeric designators. Further, while the present invention has been discussed in the context of implementations using discrete electronic elements or circuitry (preferably in the form of one or more integrated circuit chips), the functions of any part of such circuitry may alternatively be implemented using one or more appropriately programmed processors, depending upon the signal frequencies or data rates to be processed. Moreover, to the extent that figures illustrate diagrams of the functional blocks of various embodiments, the functional blocks are not necessarily indicative of the division between hardware circuitry. Thus, for example, one or more of the functional blocks may be implemented in a single piece of hardware.

In accordance with the presently claimed invention, circuitry and a method are provided for using a voltage to drive a light emitting diode (LED) load including one or more LEDs. The incoming voltage is switched and inductively conditioned to drive the LED load in such a manner as to cause the LED load to appear as a substantially linear resistive load, thereby maximizing the power factor presented to an AC power grid serving as the source of the input voltage.

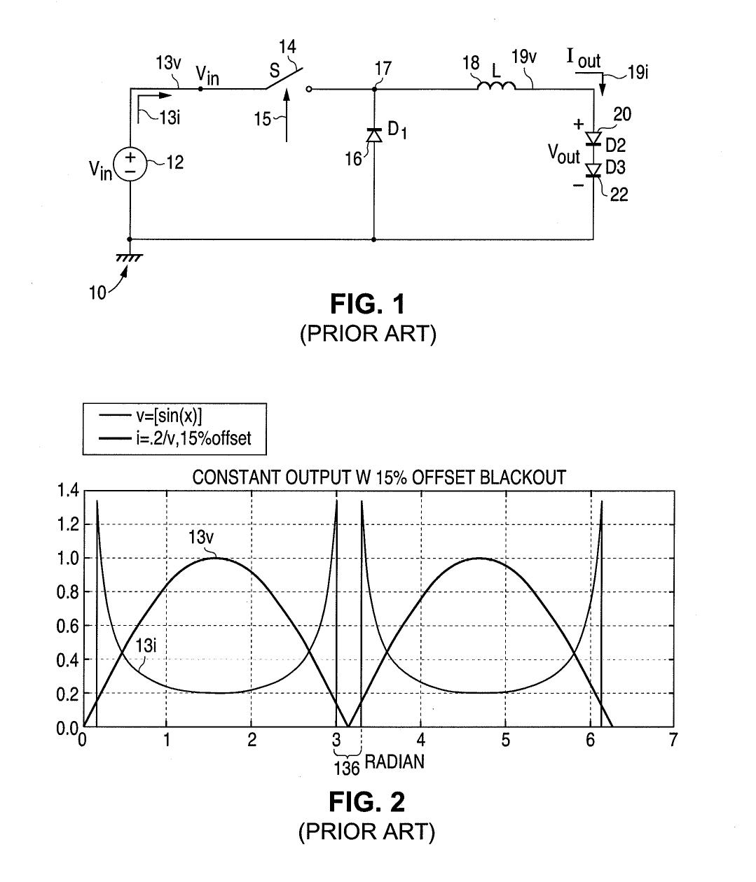

Referring to FIG. 1, a buck LED driver circuit includes a first branch consisting of a DC voltage source 12 of a rectified-AC voltage waveform and an input switch 14 coupled in series, a second branch consisting of a shunt diode 16, and a third branch consisting of an inductor 18 and a load including multiple LEDs 20, 22 all coupled in series. (Alternatively, the second branch can include, in place of the diode 16, a synchronous switch (not shown) operating in a mutually exclusive manner relative to the series switch 14, or both the diode 16 and a synchronous switch mutually coupled in parallel.) The three branches are coupled in parallel such that, when the switch 14 is closed, the diode 16 in the second branch is reverse biased and the LEDs 20, 22 in the third branch are forward biased. The ordering of serially coupled elements in a branch is not critical and can be altered. As is well known, a resistor can be connected in series with the LEDs 20, 22 for sensing the load current. Alternatively ESR of the inductor 18 can be used to measure the load current with an appropriate filtering.

The switch 14 is switched rapidly in accordance with a switch control signal 15 having a switching signal period P and duty cycle D, with the duty cycle D representing the percentage of on, or closed, state of the switch 14 during which the current 13i flows through the inductor 18 and the load LEDs 20, 22. The shunt diode 16 is reverse-biased by the DC voltage source 12 during the on state of the switch 14. During this time, the current 19i is increasing at a rate proportional to a difference between the Vin input voltage 13v and Vout output voltage 19v across the LED load 20, 22. When the switch 14 is in off, or open, state, the inductor current 19i continues to flow through the shunt diode 16 and the load LEDs 20, 22. During this time, this current 19i is decreasing (due to the collapsing magnetic field of the inductor 18) at a rate proportional to the output voltage 19v assuming continuous mode of the buck LED driver operation (i.e., the inductor current 19i remains positive at all time). Under steady state continuous-mode operating conditions, the current increment in the switch on state and current decrement in the switch off state balance each other in accordance with equation 1:

(Vin−Vout)*D=Vout*(1−D) (1)

Accordingly, the output voltage and duty cycle can be computed in accordance with equations 2 and 3:

Vin*D=Vout (2)

D=Vout/Vin (3)

Since the duty cycle D cannot be greater than unity, the output voltage 19v is less than or equal to the input voltage 13v (=that is, Vout<=Vin, hence, the name “buck” or “step down” voltage converter). In practice, the input voltage is greater than the output voltage by some margin for practical buck LED drivers.

As can be seen, the steady state relationship of equation 2 is independent of the output load characteristics. In other words, it is possible to achieve any output voltage that is less than the input voltage by appropriately adjusting the duty cycle D. Conventional buck LED drivers maintain a constant LED load current 19i, and thus a constant output voltage 19v, irrespective of the input voltage 13v by controlling the duty cycle D, typically using a negative feedback control loop.

Referring to FIG. 2, if the buck LED driver circuit 10 is driven in such manner providing a constant 0.2 watt power to the LED load with the input voltage 13v having a waveform in accordance with equation 4:

vᵢₙ=|sin(x)| (4)

then, the input current 13i has a value in accordance with equation 5:

iᵢₙ=0.2/vᵢₙ (where vᵢₙ>15% of its peak) (5)

This is based on minimum input voltage of the buck LED driver being 15% of its peak. The output blackout 13b below this 15% threshold voltage cuts the current 13i off as the input voltage goes beneath this threshold. Irrespective of the particular behavior under this threshold voltage, the input current-voltage relationship as shown indicates a serious distortion power factor to the AC power grid. Accordingly, the constant DC current driving of the load LEDs 20, 22 is not desirable or appropriate for this rectified-AC input buck LED driver 10.

Referring again to FIG. 1, for a given output voltage 19v across the LED load 20, 22, the lout output current 19i can be computed with the LED load resistance R in accordance with equation 6:

Iout=Vout/R (6)

The output power Pout consumed by the LED load can be computed in accordance with equation 7:

Pout=Iout*Vout=(Vout)²/R (7)

Ideally, if no power is consumed by other components in the circuit 10, the input power Pin provided by the input power source 12 is the same as the output power Pout, in accordance with equation 8:

Pin=Pout=(Vout)²/R=(Vin)²*D²/R (8)

This indicates that the LED load resistance R is amplified by a factor of 1/D² as seen by the input voltage source 12, thereby presenting an equivalent input resistance of R/D².

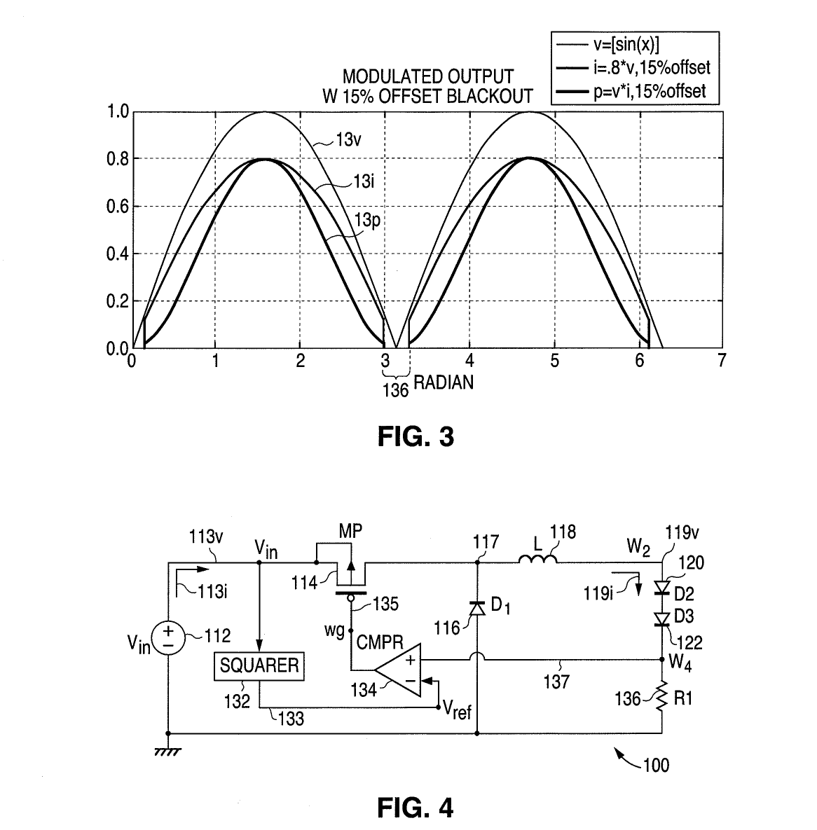

Referring to FIG. 3, if the load resistance R is constant independent of the output voltage 19v, the duty cycle D can be fixed at a constant value. Doing so causes the output power 13p to be modulated proportional to the square of the input voltage 13v, i.e., (Vin)². (Note that these waveforms are depicted in FIG. 3 with the 15% threshold for the buck LED driver.) It can be seen that the voltage 13v and current 13i waveforms are in-phase, thereby presenting a linear resistive load (i.e., unity power factor) to the AC power source when the input voltage is above the threshold. The power waveform 13p is a DC-shifted sinusoidal (i.e., first-harmonic) wave due to the squaring of the input voltage Vin in accordance with equation 9:

Pin=(|sin(x)|)²*D²/R=(1−cos(2x)/2*D²/R (9)

The 15% threshold for 110Vrms AC mains corresponds to 23.3V and the power factor is computed to be 99.8%. Double the threshold to 30% at 46.67V for a high brightness LED string; the computed power factor is still very high at 98.8%.

In reality, however, the LED load resistance R is strongly non-linear and a function of the output voltage 19v. If the duty cycle D is fixed, this non-linearity will also be seen by the input voltage source 12, thereby raising the power factor issue.

In accordance with the presently claimed invention, the duty cycle D can be dynamically adjusted via a negative feedback control to compensate for the non-linearity of the LED load resistance R so that the term D²/R (in equation 8) remains substantially constant. In other words, the switching duty cycle of the buck LED driver is modulated so that the output power is substantially proportional to the square of the input voltage 13v. This effectively transforms the non-linear LED load characteristics into a linear resistance as presented to the input voltage source 12, and thereby, eventually to the AC power grid. As the output voltage 19v remains relatively flat (due to the exponential characteristics of the current-voltage curve of the LED load) in the range that the buck LED driver is operational, per equation 2, the feedback control loop can be simplified by using the output current rather than the output power, albeit with slightly increased non-linearity as presented to the input power source 12. The resulting LED load current is a DC-shifted sinusoidal (mostly first-harmonic) waveform.

Referring to FIG. 4, a buck LED driver 100 in accordance with one embodiment of the presently claimed invention uses a P-type MOSFET transistor 114 as the series input switch 14 (FIG. 1), and includes a voltage squaring circuit 132, a voltage comparator 134 and a current-sensing resistor 136 that is coupled in series with the load LEDs 120, 122 and the inductor 118. The squaring circuit 132 provides a reference voltage 133 that is proportional to the input voltage 113v squared, to the voltage comparator 134. The load current 119i develops a corresponding voltage drop 137 across the series output resistor 136. This voltage 137 is compared with the reference voltage 133 by the voltage comparator 134 to provide the control signal 135 for the switching transistor 114. The comparator 143 along with the current sensing signal 137 and the reference signal 133 form a negative-feedback control loop, thereby ensuring the LED load current 119i to follow the reference signal 113.

For purposes of simulation of the operation of this circuitry 100, an input voltage source 112 provides a piecewise-linear voltage waveform 113v that swings between zero and 4.5 volt with 60 microsecond rise and fall times. The inductor 118 has an inductance of 50 μH, and the output current-sensing resistor 136 has a resistance of one ohm to measure the LED load current 119i. The voltage comparator 134 has a hysteresis of 0.02 volt. The squaring circuit 132 squares the input voltage 113v and divides it by a factor of 100.

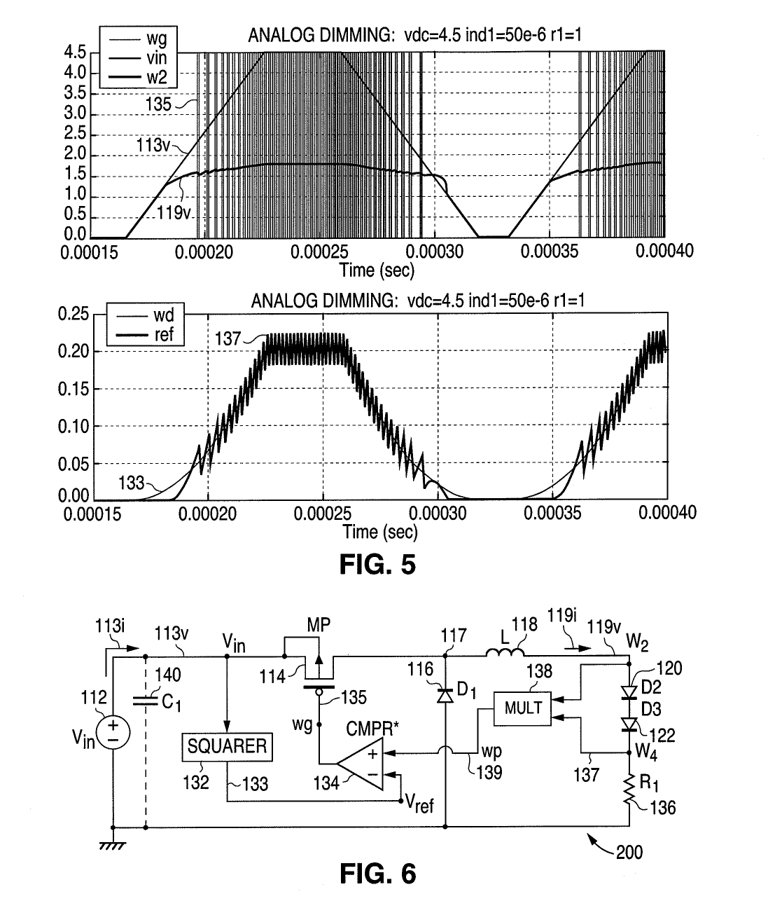

Referring to FIG. 5, the simulation results for the circuit 100 of FIG. 4 can be seen. The switching transistor 114 is switching when the input voltage 113v and the output voltage 119v are above 1.8 volt and 1.5 volt, respectively. The output voltage 119v remains relatively flat in the range where the transistor 114 is switching. The output current 119i, as represented by the voltage 137 across the resistor 136, is following the reference voltage 133 closely with a ripple of 0.04 volt (i.e., double the hysteresis of the voltage comparator 134) when the input voltage 113v is above 1.8 volt. When the input voltage 113v is below 1.8 volt, the transistor 114 is not switching and the output current 119i is not closely controlled.

Referring to FIG. 6, a buck LED driver circuit 200 in accordance with another embodiment of the presently claimed invention is similar to the circuit 100 of FIG. 4 but with the addition of a multiplier circuit 138 which multiples the voltage 137 across the current-sensing resistor 136 and the output voltage 119v across the entire output load. The resultant product signal 139, which represents the output power, is provided to the comparator 134 instead of the current-sensing signal 137 as the feedback signal so that the output power rather than the output current follows the reference signal 133. A small capacitor 140 is optionally coupled across the input voltage source 112. The operation of this circuit 200 causes the transistor 114 to be turned off, i.e., open-circuited, when the input voltage 113v falls below a minimum input voltage. If the input voltage source 112 is provided by a diode-bridge rectifier, the optional input capacitor 140 holds the minimum voltage which can be useful to provide sustained power for the controller.

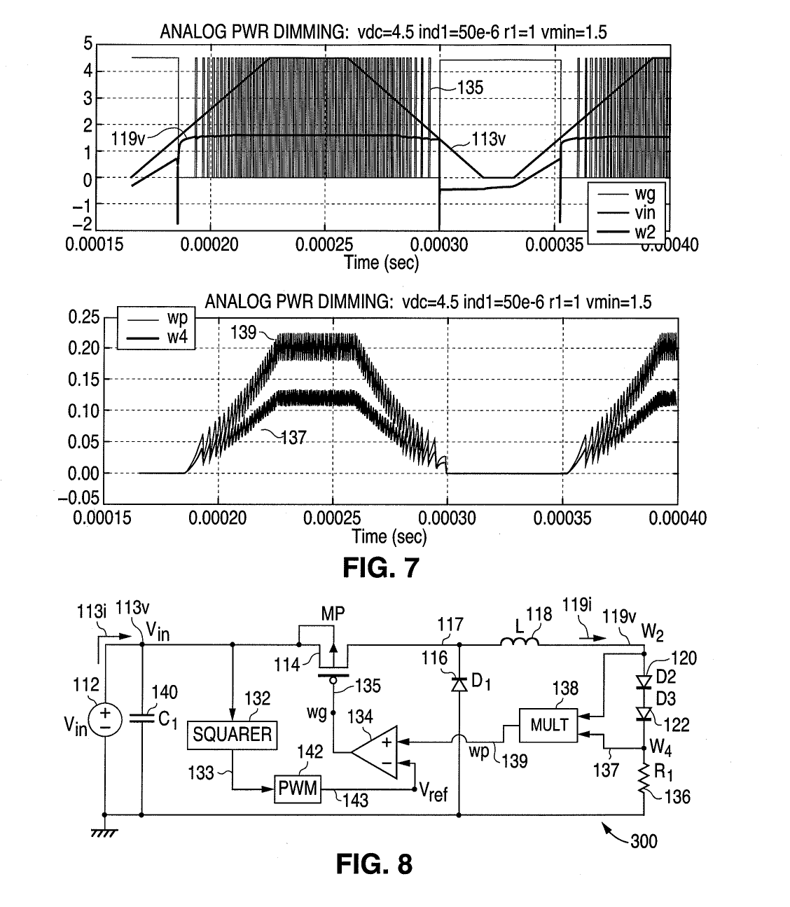

Referring to FIG. 7, simulation results for the operation of this circuit 200 can be seen. The output power, as represented by the signal 139, follows the reference voltage 133 closely when the input voltage 113v is above the minimum voltage of 1.5 volt. The output voltage 119v remains relatively constant at approximately 1.7 volt when the transistor 114 is switching. As such, the output current 119i as represented by the current-sensing signal 137 also follows suit. When the input voltage 113v falls below the minimum input voltage of 1.5 volt, the transistor 114 is turned off and the output current as represented by the voltage 137 is forced to zero.

Thus far, the operation of the buck LED driver circuitry has been assumed to be in continuous mode. However, even if the buck LED driver circuitry is operating in discontinuous or other modes of operation, it can still be modulated to present a substantially linear resistive load to the input power source 112 (and eventually to the AC power grid). For example, pulse width modulation (PWM) of the buck LED driver can be added. The discrete time modulation provided by PWM allows the output current 119i to be periodically alternated between a constant non-zero DC current and a zero current. The period of a PWM signal is order of magnitude longer than that of the switching frequency of the buck LED driver circuitry described thus far. That is, the PWM operates on top of a constant-output continuous mode buck LED driver operation, and the actual output is effectively controlled by the pulse width (duty cycle) of the discrete-time PWM.

Referring to FIG. 8, a buck LED driver circuit 300 in accordance with another embodiment of the presently claimed invention includes a PWM circuitry 142 inserted between the squaring circuit 132 and the comparator 134. The PWM circuitry 142 samples the input-squared signal 133 in a discrete time period and produces a corresponding pulse for the reference signal 143. The pulse amplitude is fixed but the pulse width corresponds to the sampled value. The comparator 134 along with the rest of the feedback control circuitry ensures the output power 139 to follow the pulse reference signal 143. Additionally, as discussed above, an input shunt capacitor 140 is included.

For purposes of simulation, the input voltage 113v has a 120 Hz piecewise-linear waveform with 3.01 millisecond rise and fall times. The PWM circuitry 142 periodically samples the squared input voltage 133 at a 6 kHz frequency and accordingly modulates the pulse reference voltage 143 by alternating between zero and 0.1 volt.

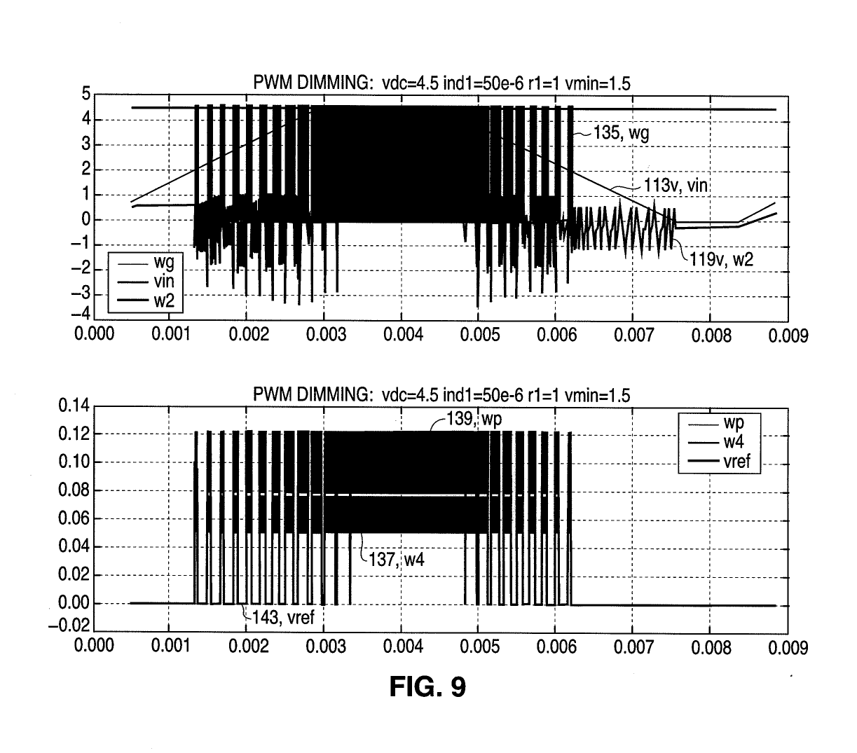

Referring to FIG. 9, the simulation results for this operation of the circuit 300 can be seen. The pulse width of the output power, as represented by the product signal 139 of the multiplier 138, is modulated proportional to the sampled input-squared voltage 143 when the input voltage 113v is higher than the minimum input voltage of 1.8 volt, and zero otherwise (i.e., for the sub-threshold blackout interval). That is, the effective output power 139 time-averaged over the PWM pulse period is proportional to the input voltage squared when the input voltage 113v is higher than the minimum input voltage. It should be understood that the voltage 137 corresponding to the output current 119i could be used instead of the product voltage 139 from the multiplier 138 to provide the feedback signal to the voltage comparator 134.

To be more precise, the PWM circuitry 142 measures, or samples, the square of the input voltage 133 by averaging it over a PWM period (set to 1/6,000 second for purposes of the simulation) and drives the reference voltage 143 in the following PWM period. Note that the pulse width of the reference voltage 143 in the next PWM period is proportional to the PWM sample value measured in the current PWM period. In other words, the output current 119i is delayed by one PWM period (1/6,000 second or r/50 radians) with respect to the input voltage 113v.

For example, if the input voltage 113v is defined in accordance with equation 11:

v=V*sin(wt) (11)

Then, the input current 113i is defined in accordance with equation 12:

i=I*sin(wt−θ)=I*cos(θ)sin(wt)−I*sin(θ)*cos(wt) (12)

where θ corresponds to the phase delay of the output current 119i due to the PWM sampling-modulation delay. The second term in equation 12 represents a reactive (inductive) component of the input current 113i. The peak input current corresponds to the non-zero DC output current 119i multiplied by the duty cycle D at that time. Since the duty cycle D is defined in accordance with equation 3, the peak reactive current component is defined in accordance with equation 13:

I*sin(θ)=0.063*(1.7/4.5)*sin(π/50)=1.49 mA (13)

Accordingly, in order to cancel the reactive component of the input current 113i and present a purely resistive load to the rectified-AC voltage source 112 (and eventually to the AC power grid), the additional input capacitor 140 should have a value defined in accordance with equation 14:

I*sin(θ)/(V*2*pi*f)=0.88 uF (14)

This capacitance of the input capacitor 140 will also smooth, i.e., filter, switching components of the input current 113i out when the input voltage 113v is above the minimum input voltage of the bulk LED driver circuit 300, and also keep the minimum input voltage otherwise as the switching transistor 114 is turned off.

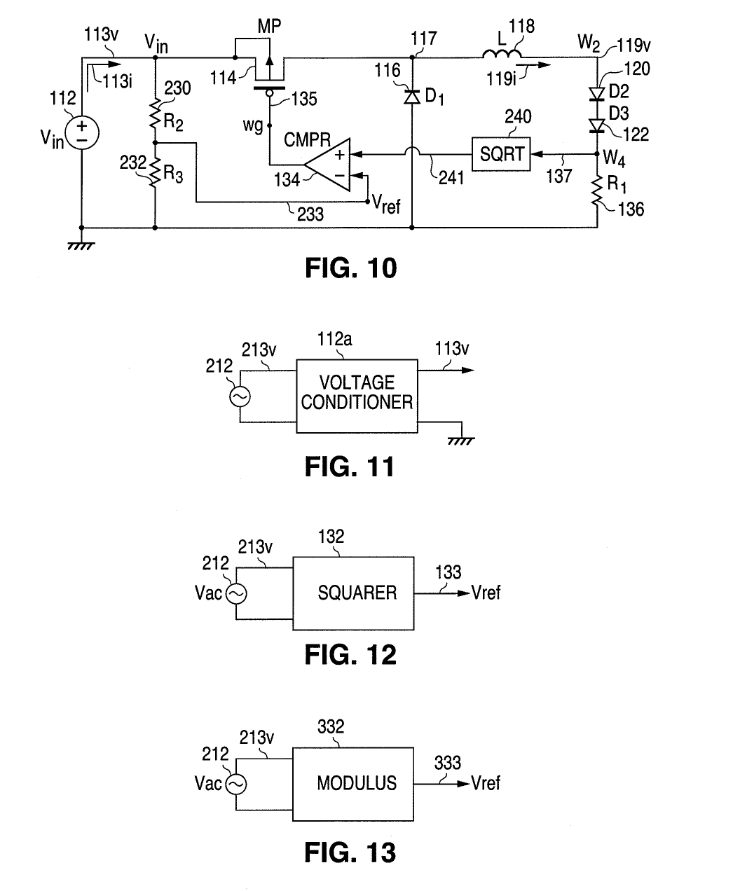

Referring to FIG. 10, an alternative to the circuit of FIG. 4 uses a square-root circuit 240 to generate the feedback signal 241 instead of using squaring function circuit 132 for the Vref signal 133 in FIG. 4. The input resistors 230, 232 provide a Vref signal 233 by attenuating the input signal Vin. This circuit of FIG. 10 also provides the feedback signal 241 to follow the reference voltage signal 233 thereby modulating the output current proportional to the input voltage squared. To encompass all cases, if the Vref signal 233 with respect to the input voltage Vin is considered a first function and the feedback signal 241 with respect to the output power (or current) is considered a second function, then a function composition of the first function and inverse function of the second function needs to be substantially a square law function for the same outcome of modulating the output power (or current) proportional to the input voltage squared.

Referring to FIG. 11, the input voltage 113v can be obtained by conditioning voltage 213v from an AC power grid 212 (e.g., half-wave or full-wave voltage rectification) with appropriate voltage conditioning circuitry 112a, in accordance with techniques well known in the art. Thus, we generalize the function composition relationship above as: If the reference signal with respect to the AC power voltage is a first function and the feedback signal with respect to the output power (or current) is a second function, then a function composition of the first function and inverse function of the second function needs to be substantially a square law function.

Although the input voltage has been discussed as a rectified AC voltage source and this is a preferred embodiment, the input voltage 113v can be any power supply derived from the AC power grid 212. Even the AC voltage 213v from the power grid 212 can be directly used for the input voltage Vin if the input switch 114 is appropriately implemented for the AC input. In such a generalized circuit, the Vref control signal 133, 233 is better linked to the AC voltage 213v of the power grid 212 instead of the conditioned input voltage Vin 112. For example, if the first function for the Vref signal is a squaring function as in the circuit of FIG. 4, the squaring circuit 132 can be coupled to the AC voltage source Vac as shown in FIG. 12. If the second function for the feedback signal is a square-root function as in the circuit of FIG. 10, an absolute value function (also called a modulus function) circuit 332 should be coupled to the AC voltage source Vac as shown in FIG. 13 to provide the Vref signal 333. Any intermediate DC power supply will benefit from the ripple output modulation of the presently claimed invention in achieving a high power factor or a low ripple voltage of the DC power supply even with reduced DC link capacitance.

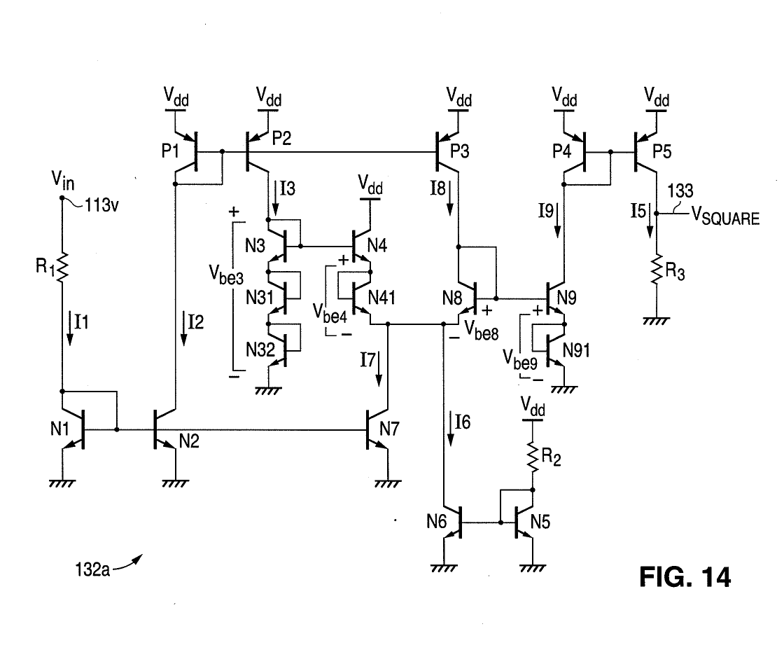

Referring to FIG. 14, an exemplary embodiment 132a of the voltage squaring circuit 132 (FIGS. 4, 6 and 8) can be implemented using PNP bipolar junction transistors P1, P2, P3, P4, P5 and NPN bipolar junction transistors N1, N2, N3, N31, N32, N4, N41, N7, N8, N6, N5, N9, N91, and resistors R1, R2, R3, all interconnected substantially as shown. The input voltage 113v establishes an input current I1 that produces two replicated, or mirrored, currents I2, I7. Current I2 is further mirrored to product currents I3 and I8. The transistors N3, N31, N32, N4, N41, N8, N9, and N91 form an alternating translinear (TL) loop in which the summation of base-emitter voltages is zero. Vbe3 represents summation of the base-emitter voltages of transistors N3, N31, and N32 that flow the same current I3. Vbe8 represents base-emitter voltage of transistor N8 that flows the current I8 (and I7). Vbe4 represents base-emitter voltages of transistors N4 and N41; current I6 flows through these transistors. Vbe9 represents base-emitter voltages of transistors N9 and N91; current I9 flows through these transistors and is mirrored in current I5 to establish Vsquare output voltage across resistor R3. Thus, the TL loop dictates the following equation 15:

Vbe3+Vb8=Vb4+Vbe9 (15)

Due to the exponential I-V characteristics of bipolar transistors, the summation equation 15 becomes a product relation of currents in accordance with equation 16:

I3**3*I8=I6**2*I9**2 (16)

I3 and I8 are same as the input current I1. Current I6 provides a constant factor in the equation 16. Resistor R2 together with the current mirror circuit of transistors N5 and N6 determines the current I6. Thus, the equation 16 can be rewritten into a square-law equation 17:

I9=(I1**2)/I6 (17)

The current I9 provides an input current to an output current mirror P4, P5. The mirrored output current I5 establishes the output voltage 133 across an output resistor R3, which corresponds to a square of the input voltage 113v.

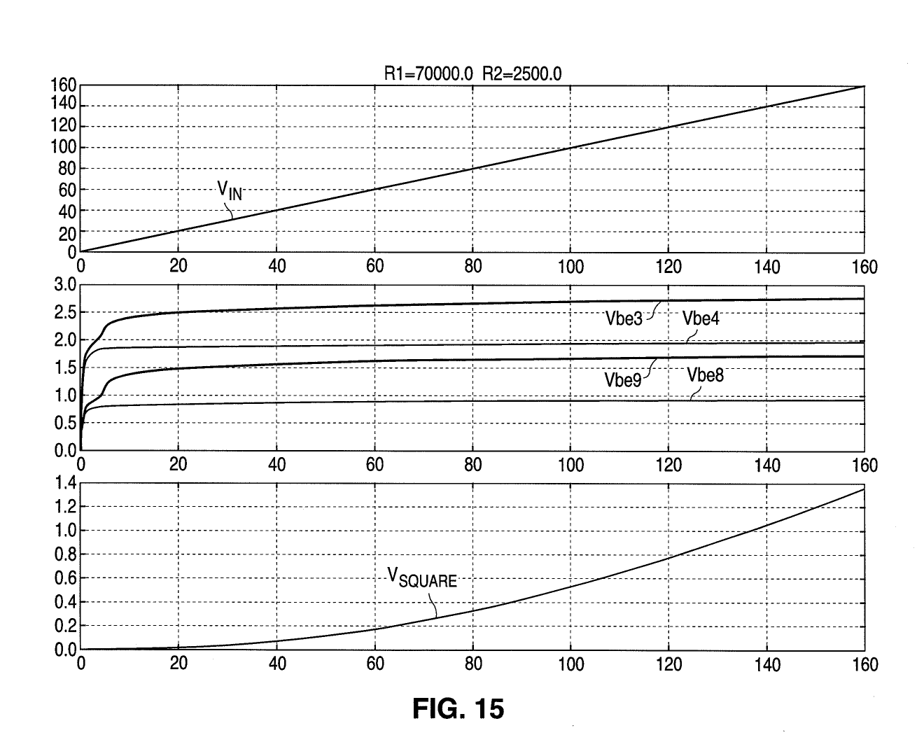

Referring to FIG. 15, the simulation results for the operation of this circuit 132a can be seen. As Vin input voltage 113v is increased in a linear manner (top graph), the base-emitter junction voltages Vbe3, Vbe4, Vbe8, Vbe9, as identified in FIG. 13, become established as their associated transistors turn on (middle graph), and Vsquare output voltage 133 is produced corresponding to a square of the input voltage 113v (bottom graph).

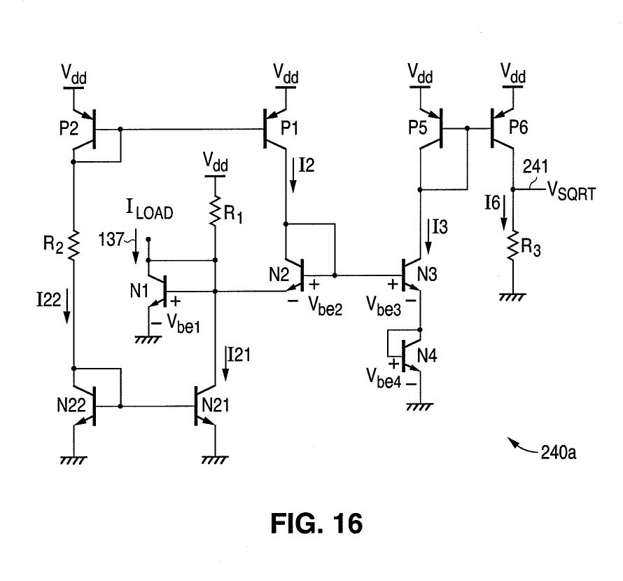

Referring to FIG. 16, an exemplary embodiment 240a of the square-root circuit 240 (FIG. 10) can be implemented using PNP transistors P1, P2, P5, P6, NPN transistors N1, N2, N3, N4, N21, N22, and resistors R1, R2, R3, all interconnected substantially as shown. The transistors N1, N2, N3 and N4 form a stacked TL loop in accordance with equation 18 of the base-emitter voltages:

Vbe1+Vb2=Vb3+Vb4 (18)

The load current I37 flows through a diode-connected transistor N1, developing the base-emitter voltage Vbe1. Resistor R2 along with transistors P2 and N22 establishes a current I22, which is replicated, or mirrored, in current I21 by a current mirror N21, N22. The current I22 is further mirrored by another current mirror P1, P2 to produce an input current I2 to a diode-configured transistor N2, thereby establishing the base-emitter voltage Vbe2. Resistor R2 provides a small offset current. The exponential I-V characteristics of bipolar transistors in the TL loop transform the voltage summation equation 18 into a product relation of currents in accordance of equation 19:

Iload*I2=I3**2 (19)

as I2 is constant, the equation 19 is rewritten into a square-root equation 20 of the load current Iload:

I3=I2**(½)*Iload**(½) (20)

Note that if the current I2 corresponds to effective load voltage, then I3 corresponds to a square root of effective load power. The current I3 provides an input current to an output current mirror P5, P6, with the resulting mirrored current I6 establishing the output voltage 241 across an output resister R3, which corresponds to a square root of the load current Iload 137.

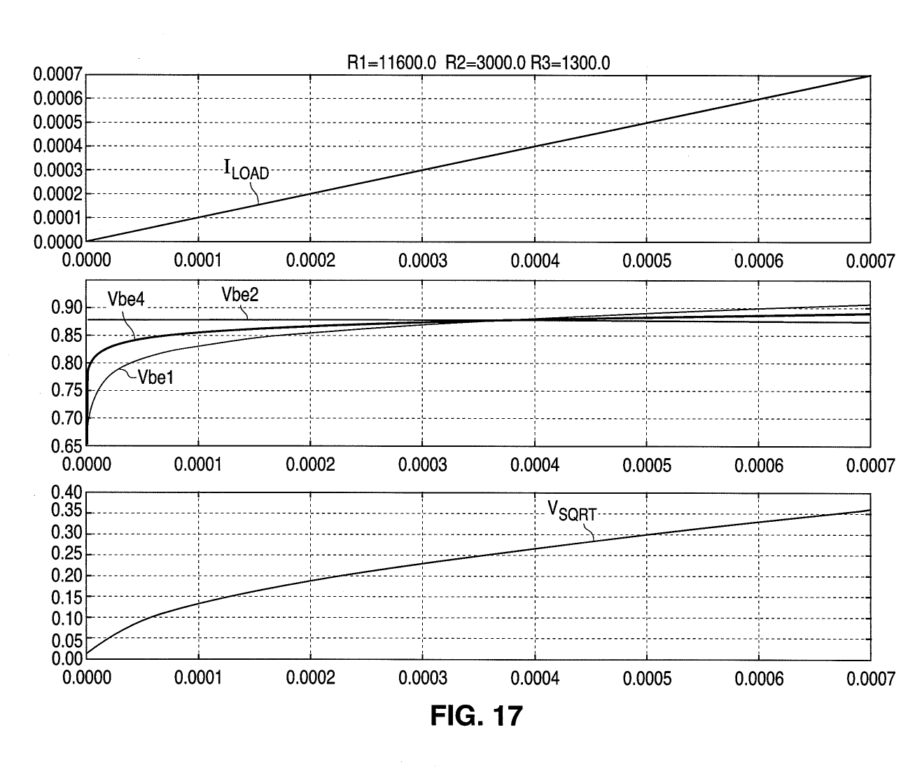

Referring to FIG. 17, the simulation results for the operation of this circuit 240a can be seen. As the load current Iload 137 is increased in a linear manner (Iload in top graph), the base-emitter junction voltages Vbe1, Vbe2, Vbe4, as identified in FIG. 15, become established as their associated transistors turn on (middle graph), and the Vsqrt voltage 241 increases with a magnitude corresponding to a square root of the Iload signal 137 (bottom graph).

Thus far, the discussion has been based on obtaining a feedback signal from the output, e.g., the third branch, related to the effective LED power and in the form of a signal indicative of the load current 119i. However, it will be apparent to and understood by one of ordinary skill in the art that a feedback signal suitable for use by the control circuitry, e.g., the comparator 134, can also be obtained from elsewhere, such a sampled signal indicative of the load current as it is conducted via the input switch 114 during its on state, or a signal indicative of the load current as it is conducted via the diode 116 during the off state of the input switch 114, since such other signals are indicative of output power (or current).

Various other modifications and alternations in the structure and method of operation of this invention will be apparent to those skilled in the art without departing from the scope and the spirit of the presently claimed invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. An apparatus including light emitting diode (LED) driver circuitry for providing an LED power substantially related to a square of an AC power voltage, comprising:
a first circuit branch including first switching circuitry and responsive to a first switch control signal and an input voltage related to said AC power voltage by providing a switched voltage having a switched voltage cycle associated therewith;
a second circuit branch including shunt current conduction circuitry, coupled to said first circuit branch and responsive to said switched voltage and a load current related to said LED power by conducting said load current during at least a portion of said switched voltage cycle;
a third circuit branch including inductive LED circuitry, coupled to said first and second circuit branches, and responsive to said switched voltage by conducting said load current;
reference circuitry responsive to one of said AC power voltage and said input voltage by providing a reference signal related to said AC power voltage in accordance with a first function;
feedback circuitry coupled to at least one of said first, second and third circuit branches, and responsive to at least one signal therefrom related to said load current by providing a feedback signal related to said LED power in accordance with a second function, wherein a composite of said first function and an inverse of said second function substantially comprises a quadratic function; and
control circuitry coupled to said reference circuitry, said feedback circuitry and said first circuit branch, and responsive to said feedback signal and said reference signal by providing said first switch control signal.

2. The apparatus of claim 1, wherein said input voltage comprises a rectified voltage.

3. The apparatus of claim 2, wherein said rectified voltage comprises a full-wave rectified voltage.

4. The apparatus of claim 1, wherein said shunt current conduction circuitry comprises a diode.

5. The apparatus of claim 4, wherein:
said shunt current conduction circuitry further comprises second switching circuitry coupled to said diode and responsive to a second switch control signal;
said control circuitry is responsive to said feedback signal and said reference signal by further providing said second switch control signal; and
said first and second switch control signals are substantially mutually exclusive.

6. The apparatus of claim 1, wherein said third circuit branch comprises a resistance responsive to said load current by providing a feedback voltage as said feedback signal.

7. The apparatus of claim 1, wherein said reference circuitry comprises signal squaring circuitry.

8. The apparatus of claim 1, wherein said feedback circuitry comprises signal multiplying circuitry coupled to said at least one of said first, second and third circuit branches and responsive to a plurality of signals therefrom.

9. The apparatus of claim 1, wherein said reference circuitry comprises pulse width modulation (PWM) circuitry.

10. The apparatus of claim 1, wherein said feedback circuitry comprises square-root circuitry.

11. The apparatus of claim 1, further comprising a capacitance coupled to said first circuit branch to receive said input voltage.

12. An apparatus including light emitting diode (LED) driver circuitry for providing an LED power substantially related to a square of an AC power voltage, comprising:
switching means for responding to a switch control signal and an input voltage related to said AC power voltage by providing a switched voltage having a switched voltage cycle associated therewith;
shunt current conduction means for responding to said switched voltage and a load current related to said LED power by conducting said load current during at least a portion of said switched voltage cycle;
inductive LED means for responding to said switched voltage by inductively conducting said load current;
reference generator means for responding to one of said AC power voltage and said input voltage by providing a reference signal related to said AC power voltage in accordance with a first function;
feedback means for responding to at least one signal from at least one of said switching means, shunt current conduction means and inductive LED means and related to said load current by providing a feedback signal related to said LED power in accordance with a second function, wherein a composite of said first function and an inverse of said second function substantially comprises a quadratic function; and
controller means for responding to said feedback signal and said reference signal by providing said switch control signal.

13. A method of driving light emitting diode (LED) circuitry for providing an LED power substantially related to a square of an AC power voltage, comprising:
responding to a switch control signal and an input voltage related to said AC power voltage by providing a switched voltage having a switched voltage cycle associated therewith;
responding to said switched voltage and a load current related to said LED power by conducting said load current during at least a portion of said switched voltage cycle;
responding to said switched voltage by conducting said load current with inductive LED circuitry;
responding to one of said AC power voltage and said input voltage by providing a reference signal related to said AC power voltage in accordance with a first function;
responding to at least one signal related to said load current by providing a feedback signal related to said LED power in accordance with a second function, wherein a composite of said first function and an inverse of said second function substantially comprises a quadratic function; and
responding to said feedback signal and said reference signal by providing said switch control signal.

14. The method of claim 13, wherein said input voltage comprises a rectified voltage.

15. The method of claim 13, wherein said responding to said switched voltage and a load current related to said LED power by conducting said load current during at least a portion of said switched voltage cycle comprises conducting said load current with a diode.

16. The method of claim 13, wherein said responding to at least one signal related to said load current by providing a feedback signal related to said LED power in accordance with a second function comprises conducting said load current with a resistance to provide a feedback voltage as said feedback signal.

17. The method of claim 13, wherein said responding to one of said AC power voltage and said input voltage by providing a reference signal related to said AC power voltage in accordance with a first function comprises squaring said one of said AC power voltage and said input voltage.

18. The method of claim 13, wherein said responding to at least one signal related to said load current by providing a feedback signal related to said LED power in accordance with a second function comprises multiplying a plurality of signals.

19. The method of claim 13, wherein said responding to one of said AC power voltage and said input voltage by providing a reference signal related to said AC power voltage in accordance with a first function comprises pulse width modulating.

20. The method of claim 13, wherein said responding to at least one signal related to said load current by providing a feedback signal related to said LED power in accordance with a second function comprises generating a square-root signal.
